(19) United States
(12) Patent Application Publication
(10) Pub. No.: US 2009/0224510 A1
(43) Pub. Date: Sep. 10, 2009

(54) VEHICLE EXTENDER

(75) Inventors: Michael E. Caporali, Endicott, NY (US); Kenneth Gluck, Vestal, NY (US); Adam C. Hunt, Freeville, NY (US); Theresa Makarsky, Endicott, NY (US); Joseph J. Taranto, Grand Blanc, MI (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 12/041,701

(22) Filed: Mar. 4, 2008

(51) Int. Cl. B60D 1/155

(52) U.S. Cl. 280/482

(57) ABSTRACT

A vehicle extender for selective connection with a base vehicle. The extender includes a frame and two wheels on an axle which may be driveable. There are inter-engageable air, electrical and brake connectors on the frame to provide electrical and brake systems to the vehicle extender from the base vehicle, and there is a quick-connection assembly for connecting the vehicle extender to the base vehicle. There can be a combination of a base vehicle and a vehicle extender, with provision for quick connect/disconnect. The base vehicle has a chassis, a body including a cargo bed, engine, tires, an electrical system, an air system and a brake system.

### FIELD OF THE INVENTION

This invention relates generally to the vehicle art, and, more particularly to vehicle extenders.

### BACKGROUND OF THE INVENTION

U.S. Pat. No. 1,250,066 provides a trailer attachment for automobiles which may be attached to the chassis of an automobile and which is provided with means for turning the wheels of the trailer to aid in steering the assembly in an attempt to turn in less space than would ordinarily be required.

U.S. Pat. No. 3,312,479 provides a load distributing tractor-trailer assembly for maintaining both the tractor driving wheels and the auxiliary supporting wheels in surface engagement irrespective of the surface conditions encountered.

U.S. Pat. No. 4,635,742 provides an extendable chassis with an additional axle which is moved to a position with the wheels on the ground when the chassis is extended and to a position with the wheels off the ground when the chassis is retracted.

U.S. Pat. No. 4,679,634 provides an apparatus for extending the frame of a tractor so that an agricultural implement may be mounted between the front and rear wheels of the tractor.

U.S. Pat. No. 4,955,629 provides a convertible chassis for a semi-trailer that converts to an elongated, telescoped chassis to support both the semi-trailer and a trailer towed behind the semi-trailer.

U.S. Pat. No. 5,375,866 provides an extension axle apparatus for over-the-road trailer assemblies which includes a rigid connecting beam affixed to the end of the trailer bed. A parallelogram structure which connects the unit to follow directly behind the trailer.

U.S. Pat. No. 6,199,894 for an apparatus and method for a truck frame extender one end of which includes a connection that can be received by and secured into the back end of a truck frame either in the same general plane as the truck frame or it can be secured to the truck frame at a different lower or higher position.

U.S. Pat. No. 6,695,328 for a vehicle frame assembly and split-frame vehicle in which the front and rear sub-frames may rotate relative to one another along a longitudinal axis that runs generally parallel to the ground.

U.S. Pat. No. 6,969,104 provides an adjustable length chassis which is capable of being reduced in length and includes a gooseneck assembly and a rear frame assembly.

U.S. Published Patent Application Publication No. 2004/0017054 for vehicles in which the rear of a vehicle and the front of an extension unit are provided with complementary locating formations and clamping means are provided for clamping the front of the extension unit to the rear of the vehicle.

In the truck market there are requirements for many varied vehicles to support various needs. In some cases a smaller, lighter and more transportable vehicle is needed while in other cases the ability to carry more payload or personnel is needed. Typically, these varied needs result in many differently designed vehicles which are uniquely configured to support one, or a few, different needs. This causes increased costs and manufacturing complexity, as well as increased support/life cycle costs for the customer. For example, it may be necessary to have a comparatively small 4 wheeled vehicle for internal or external air transport that would allow for rapid deployment to a given location. In another case it may be necessary to have a larger vehicle, such as one with 6 wheels, to carry added payload and personnel.

There have been attempts to solve this, or similar, problems before. One example is the use of a “Tag” axle. This is an axle which is normally up off of the road surface until enough payload is placed on the vehicle to cause it to contact the ground. While this is helpful to vehicle mobility and increases payload capacity, it does not change the size or weight of the vehicle when not in use. This can be seen in various vehicles such as dump trucks and log haulers.

Another example, is a 6×6 extender frame vehicle which does not fulfill all of the needs which modern extender frame vehicles are required to handle.

Prior art structures in the vehicle field are much more cumbersome in design. They do not use quick connects nor are they self supporting. In some prior designs a rear section must be removed, the axle removed, and the rear section remounted. While some of them attempt to offer similar arrangements as the present invention they are more difficult and cumbersome in performing similar operations, and require cranes/hoists to manipulate the sections. This results in less flexibility in the field and requires much time to remove and remount.

### SUMMARY OF THE PRESENT INVENTION

The present invention provides for two types of vehicles in one venue at any given time, namely a 4×4 and a 6×6 vehicle.

In one embodiment of the present invention an add-on axle on an extender is provided that can convert a 4×4 vehicle into a 6×6 vehicle. The third axle can be a driven axle, if desired. The arrangement uses elements in the vehicle frame to allow for attachment, such as via bolts. All connections (brakes, electrical, suspension air, and CTIS air) are made with quick connect couplings. The third axle has supports built in that allow for easy handling when separated from the main vehicle. Removal or installation of the third axle can be accomplished in 30-45 minutes with the truck's basic tools.

The present invention provides a vehicle system which facilitates the rapid and easy reconfiguration of a vehicle by adding or removing axles to meet various needs. While one arrangement is used to convert a 4×4 vehicle into a 6×6 vehicle, other vehicle configurations could be arranged in a similar fashion. Additionally, it is not a requirement that all axles be driven axles. This same basic arrangement can apply to added un-driven axles as well. In this manner it is possible to deploy one vehicle type and reconfigure it in the field to support any given need and any given time. This increases vehicle commonality and reduces design time and cost, as well as manufacturing and support costs. These extender axles arrangements could be shipped at a later time so as not to impact the rapid deployment of the base 4 wheeled vehicle.

The axle extender axle can convert a 4 wheel drive vehicle into a 6 wheel drive vehicle. This extender axle is easily attached to the base vehicle by use of mechanical hardware and quick connects for air, brakes and electrical services. The third axle has its own cargo bed section which mates to the rear of the 4 wheeled vehicles cargo bed. This increases cargo capacity by 10,000 lbs, while only adding 3,000 lbs to vehicle weight. Additionally it increases personnel carrying capability by up to 6 people. The third axle is connected to the original vehicle by three bolts per side, as well as a clamp device which utilizes a tie down hole in the base vehicle and two additional bolts. A thru-shaft differential may be incorporated into the base vehicle's second axle so that an additional prop shaft could be attached and provide drive torque to the third axle when attached. Five quick connects can be used to connect services to the third axle: two for brakes, two for suspension air lines, and one for central tire inflation (CTIS). There may also be an electrical connector for power in the third axle (such as for lights, etc.). For proper alignment of the third axle frame two wedges, perpendicular to each other, can be located on the third axle frame. These wedges may be mated to notched blocks which may be welded onto the base vehicle frame.

To further simplify the process of installation/removal of the third axle mounts are designed into the extender frame which could receive dolly wheels (similar to a trailer jack wheel), and tip stands are built into the rear of the frame. In this way the third axle is totally self supporting and stable when not attached to the base vehicle. This also facilitates ease of mounting/dismounting by allowing the base vehicle to be driven up to, or away from, the extender frame. This feature makes the job fairly simple, and negates the need for heavy cranes/hoists to place the third axle into position. The entire job of mounting or dismounting can be completed in less than one hour with a two person crew, and no special tools.

The solution provided by the present invention is a much simpler in design and the operation can be accomplished in much less time and without special tools and hoists. Also, unlike the tag axle, it can reduce vehicle transport weight and length making it easier to move the vehicle to another location via aircraft/rail/ship.

Currently there is a need for many vehicles of different configurations. Sometimes vehicles available in the motor pool are larger or smaller than needed for a current activity. Additionally there is a desire to have as much commonality as possible between vehicles in a fleet.

Thus, the present invention provides an add-able/removable axle that can be quickly installed/removed to allow for rapid reconfiguration of a vehicle with no special tools.

The present invention allows one vehicle to serve multiple functions. The add on axle can greatly increase payload capability. Conversely the axle can be removed to lighten the vehicle and improve transportability. This reconfiguration can be done quickly with no special tools. The present invention provides maximum flexibility in the fleet with reduced cost. Additionally it improves parts commonality across the fleet.

As previously mentioned above, there have been previous attempts to solve this problem. However, while there are numerous advancements over the prior art as contained in the above listed patents, they do not address the attachment and/or the use of an additional axle that is similar to the present invention. For example, in the present invention the added axle is driven, there is the use of quick connects for air and brake lines, and better methods of attachment

This invention could apply to commercial vehicles as well as military vehicles.

The present invention together with the above and other advantages may best be understood from the following detailed description of the embodiments of the invention illustrated in the drawings, wherein:

### BRIEF DESCRIPTION OF THE DRAWINGS

FIG. 1 is a diagrammatic isometric view of the vehicle system of the present invention in the 6×6 configuration.

FIG. 2 is a frontal isometric view showing the entire vehicle in the 6×6 configuration.

FIG. 3 is a frontal isometric view showing the entire vehicle in the 4×4 configuration

FIG. 4 is a front isometric view of the extender showing the position of the parts of the vehicle when the extender is about to be connected.

FIG. 5 is a rear isometric view showing details of the rear connections when the vehicle is being changed from a 4×4 to a 6×6 vehicle, and showing the prop shaft connection and the quick couplings of the vehicle.

FIG. 6 is a side view showing the rear end of the 4×4 vehicle connected to the extender, and showing the driver's side mounting bolts and clamp and the dolly wheel mount for the 6×6 vehicle.

FIG. 7 is a diagrammatic isometric view of a part of the vehicle showing the lower bolt mount location.

FIG. 8 is a diagrammatic isometric view of a part of the vehicle showing the positioning clamp from the third to the second axle.

FIG. 9 is a diagrammatic plan view showing the second and third axle sections.

FIG. 10 is a diagrammatic isometric view showing the extender frame

FIG. 11 is a diagrammatic isometric view showing details of the structure shown in FIG. 10, including the wedge blocks.

FIG. 12 is a diagrammatic isometric view showing the base vehicle main frame.

FIG. 13 is a diagrammatic isometric view showing details of the structure shown in FIG. 12, including the V-grooves.

FIG. 14 shows the rear tip supports of the 6×6 vehicle in the folded up position.

FIG. 15 is an isometric view is an isometric view of a part of the vehicle showing the upper bolt location for connection of the third axle.

### DETAILED DESCRIPTION OF PREFERRED EMBODIMENTS

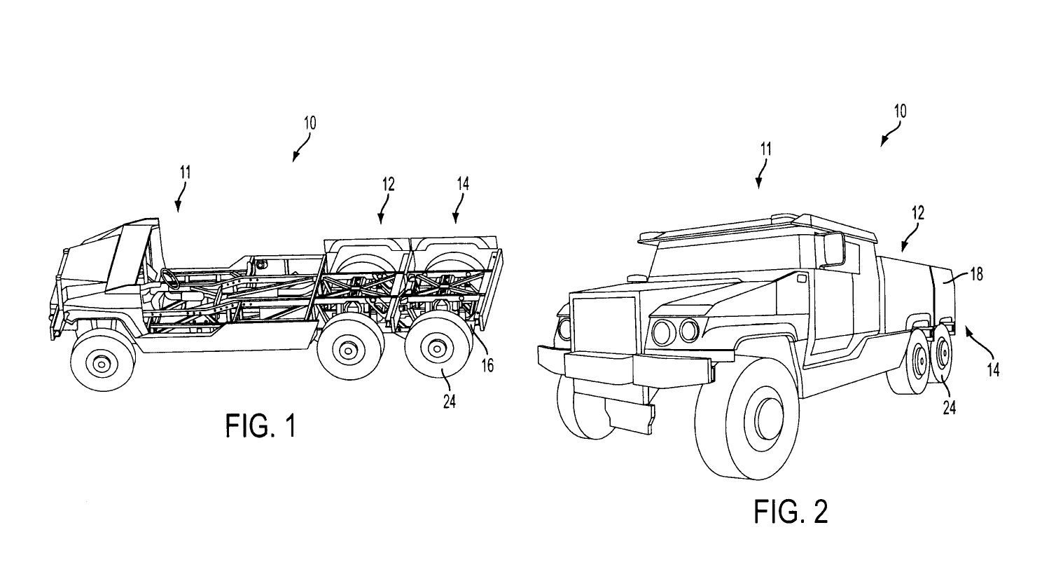

The present invention provides a tactical military vehicle 10 (FIGS. 1-4), which could also be a civilian vehicle, having a driver section 11 and a cargo bed section 12. In this figure the vehicle is a 6×6 vehicle showing it with a third axle attached by attaching an extender 14 with a third axle 16. In FIG. 1 most of the body has been removed to show the support and connection structures. The complete vehicle in the 6×6 configuration is shown in FIG. 2 in which the cargo bed 12 of the main vehicle is aligned with the cargo bed 18 of the extender to form a larger cargo bed.

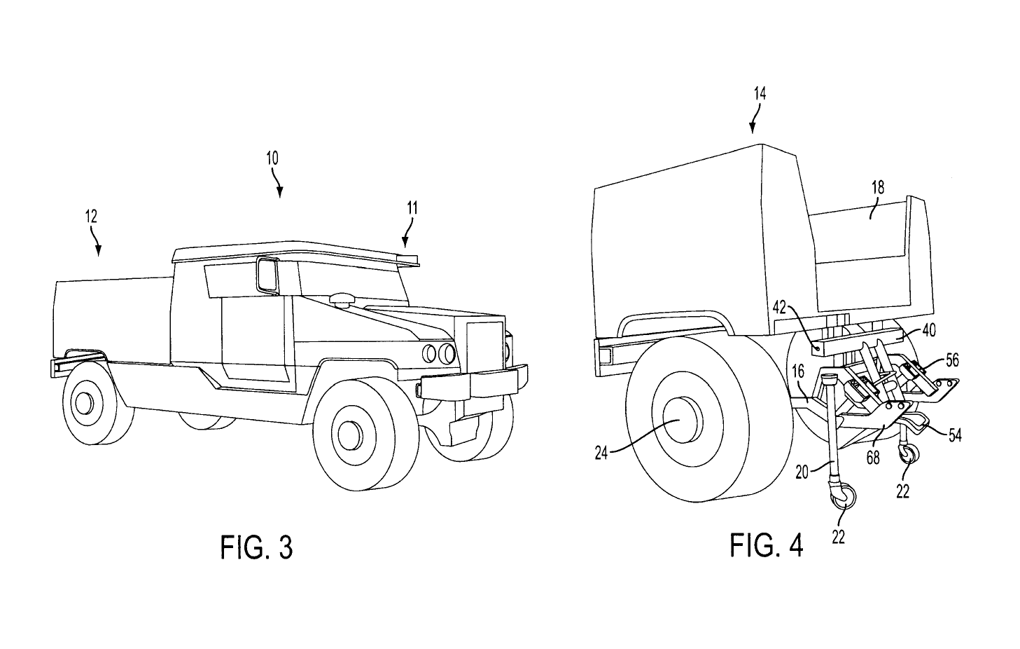

The 4×4 vehicle is shown in FIG. 3. The third axle 16 and the extender 14 are shown in FIG. 4, which has been removed from the main vehicle. FIG. 4 shows the front of extender 14, which attaches to the rear of the main vehicle. The extender 14 has dolly legs 20 attached to the extender so that it can be positioned to be attached to the main vehicle by being wheeled into place using the two wheels 22 of the dolly legs and the two wheels 24 of the extender. The dolly is formed by the two wheeled legs 20 with wheels 22 so that the structure has four wheels when it is not being used and can be wheeled to the back of the 4×4 vehicle when attachment of the extender is desired. When the extender is attached to the main vehicle, the dolly legs and wheels can be pivoted out of the way or removed, as desired.

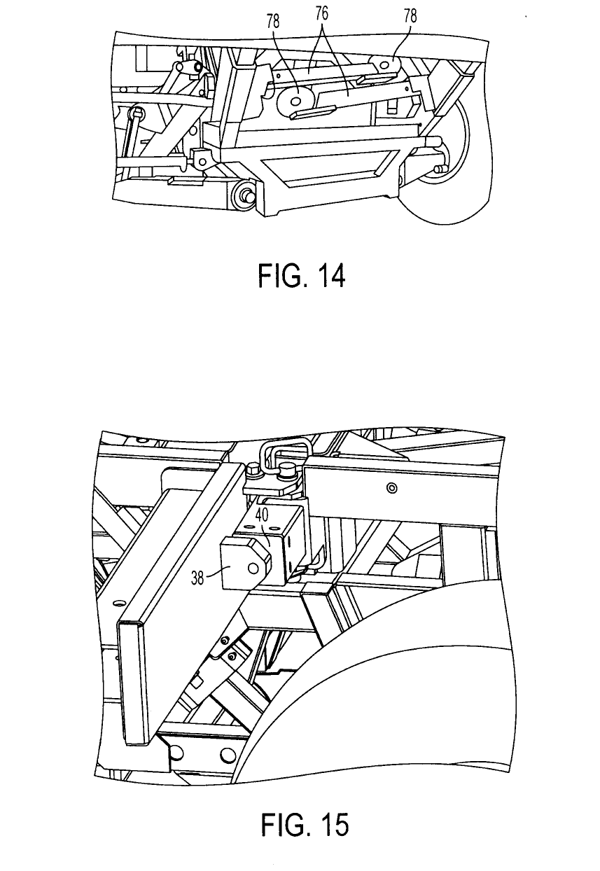

As shown in FIG. 14, which provides a view of the back of the extender, there are two tip legs 76, having wheels 78, to prevent the extender from tipping when it is not connected to a vehicle. FIG. 14 shows the tip legs in folded position. When they are to be used they are moved out of the folded or pivoted position.

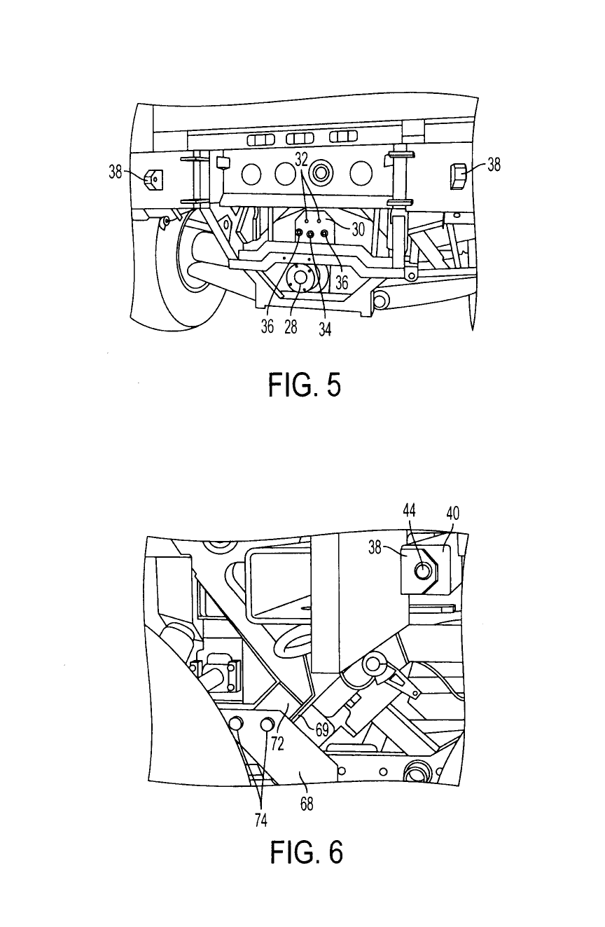

FIG. 5 shows the back of the 4×4 vehicle which includes a prop output shaft 28 which is provided to be connected to the extender and to drive the two wheels 24 of the extender as explained below (when the driven wheeled extender embodiment is used). Above the prop shaft there is a plate 30 which provides connections for the brake line 32, the CTIS air line 34, and the suspension air connections 36 (the two outer connectors). There are also electrical line connectors (not shown). There are tow eyes 38 for connection to the extender or which may be used to tow another type of equipment. FIGS. 4-6 show a cross piece 40 at the top of the dolly supported structure which has threaded holes 42 (FIG. 4) in the ends so that bolts 44 may be inserted through the tow eyes 38 and threaded into the cross piece to connect the parts together.

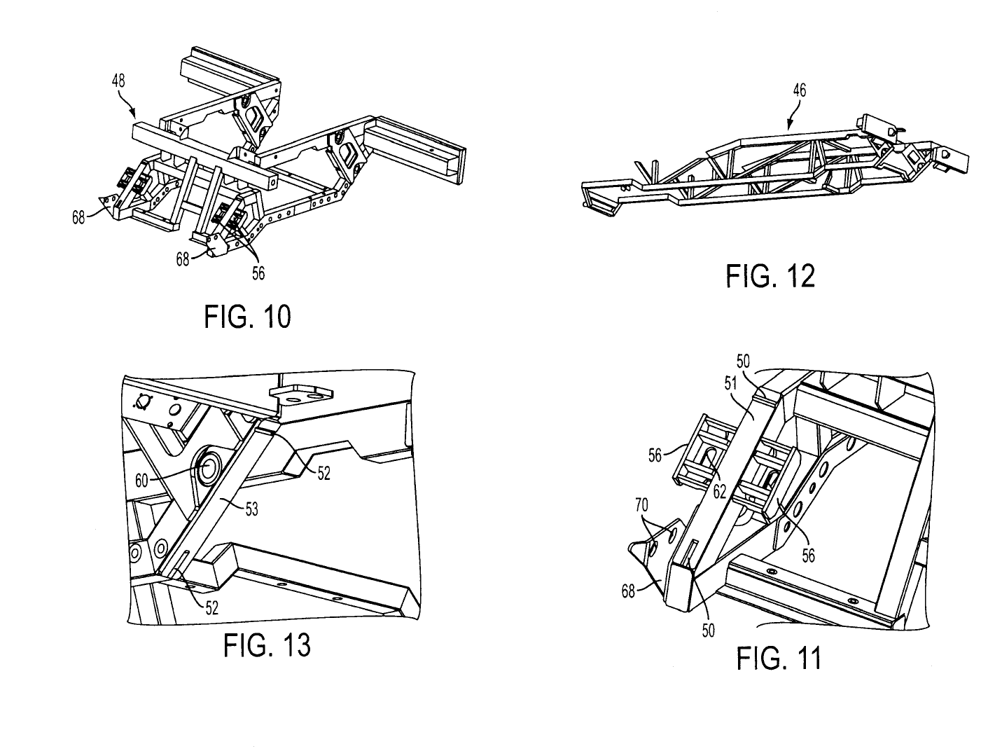

The frame 46 of the 4×4 base vehicle is shown in FIG. 12 and an enlarged portion of it is shown in FIG. 13. The frame 48 of the extender is shown in FIG. 10 and an enlarged portion of it is shown in FIG. 11. The parts 50 and 52 shown in FIGS. 11 and 13 mesh together in such manner that the V-protrusions or wedge blocks 50 of the extender frame shown in FIGS. 10 and 11 fit into the V-block notches or V-grooves 52 of the main frame shown in FIGS. 12 and 13 to provide an accurate connection between the parts. The wedge blocks 50 are on an inclined support 51 and the V-grooves 52 are formed in a matching inclined support 53. In FIG. 6 the mating line where the supports 51 and 53 meet is designated at 71. (For purposes of clarity there is a slight space shown in the drawing, but the parts are actually in contact.)

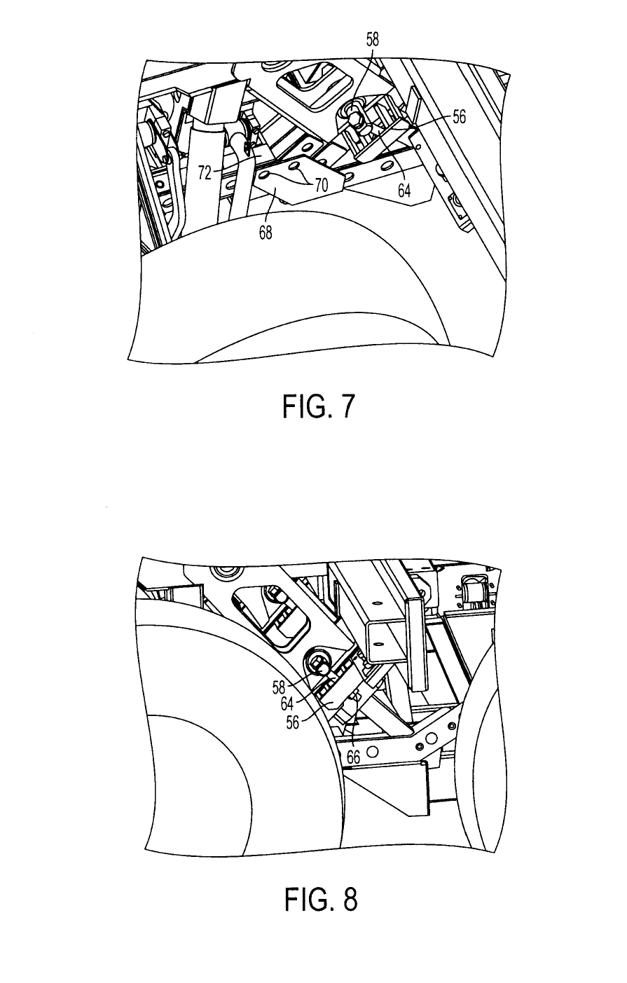

The extender 14 shown in FIG. 4 has a shaft extension 54 which connects to the output shaft 28 shown in FIG. 5. There are two boxes 56, one on each side of the extender support 51 as shown in FIGS. 4, 7, 8, 10 and 11. A pin 58 passes through the large hole 60 in the main frame adjacent to the V-grooves 52 as shown in FIGS. 7, 8 and 13. The pin 58 has an opening through which bolts 64 pass. These bolts 64 also pass through openings 62 in the boxes 56 and are held in place by nuts 66. This pin 58 and bolt 64 connection is shown in more detail in FIGS. 7 and 8, and when the nut is tightened on the bolt a clamping action of the parts takes place.

The extender frame 48 structure (See FIGS. 10 and 11) has a leg 68 on each side, the upper ends of which have two holes 70 each. These legs 68 are bolted to the main frame which has threaded blocks 72 in the vehicle frame to receive the bolts 74, as seen in FIG. 6.

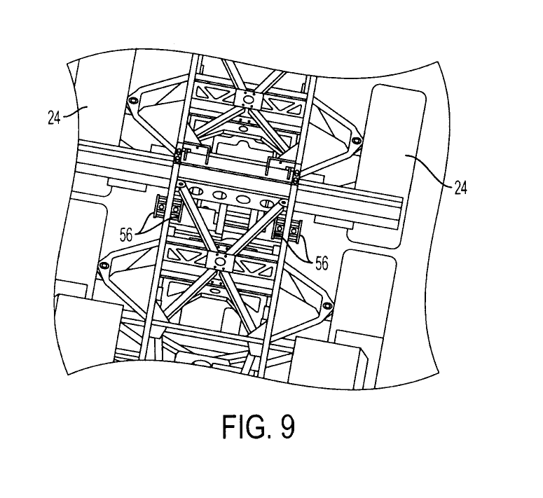

Thus, there are three connection areas. The upper one is shown in FIGS. 6 and 15 and is provided by bolts 44 through the tow eyes 38 and into the upper cross piece 40. The middle one is provided by positioning clamps and is shown in FIGS. 7-9, and is provided by the pin 58 in the hole 60 in the frame 46, and bolts 64 through the pin 58 and through the holes 62 in the boxes 56 (there are two boxes on each side of each main frame side leg) as shown in FIG. 9. and also in FIGS. 7 and 8. The lower one is shown in FIGS. 6, 7 and 11 and is provided by the leg 68 on each side of the extender frame 48 by two bolts 74 passing through the holes 70 in the leg and into threaded blocks 72 on the main frame.

Thus, the present invention satisfies a need for many vehicles of different configurations. Sometimes vehicles available in the motor pool are larger or smaller than needed for a current activity. Additionally there is a desire to have as much commonality as possible between vehicles in the fleet. The present invention provides an addable/removable axle that can be quickly installed/removed to allow for rapid reconfiguration of a vehicle with no special tools. This allows one vehicle to serve multiple functions. The add-on axle can greatly increase payload capability. Conversely, the axle can be removed to lighten the vehicle and improve transportability. This reconfiguration can be done quickly with no special tools. It provides maximum flexibility in the fleet with reduced cost. Additionally, it improves parts commonality across the fleet.

It is to be understood that the above-described embodiments are simply illustrative of the principles of the invention. Various and other modifications and changes may be made by those skilled in the art which will embody the principles of the invention and fall within the spirit and scope thereof.

1. A vehicle extender for selective connection with a base vehicle, said extender comprising:
a frame and two wheels on an axle;
inter-engageable air, electrical and brake connectors on said frame to provide electrical and brake systems to the vehicle extender from the base vehicle; and
a connection assembly for connecting the vehicle extender to the base vehicle.

2. The extender of claim 1 wherein said connection assembly provides three connection areas between the vehicle extender and the base vehicle.

3. The extender of claim 2 further comprising a driveable shaft on the extender arranged to be connected to a drive shaft on the base vehicle to provide power to the extender for driving the extender axle.

4. The extender of claim 3 further comprising a dolly and a tip stand connected to said vehicle extender for supporting the vehicle extender when it is not connected to the base vehicle.

5. The extender of claim 3 further comprising a cargo bed arranged to mate with the cargo bed of a base vehicle.

6. The extender of claim 3 wherein one of the connection areas includes two alignment wedges, one on each side of the extender for mating with notched blocks on the base vehicle.

7. In a tactical vehicle, the combination having (1) a base vehicle having a chassis, body, engine, tires, a cargo bed, and two notched blocks at the back of the chassis, an electrical system and a brake system and (2) a vehicle extender, the improvement comprising:
a vehicle extender, said vehicle extender having two wheels on an axle and a frame;
inter-engageable air, electrical and brake connectors to provide electrical and brake systems to the vehicle extender from the base vehicle; and
a connection assembly for connecting the vehicle extender to the base vehicle.

8. The improvement of claim 7 wherein said connection assembly provides three connection areas between the vehicle extender and the base vehicle.

9. The improvement of claim 8 further comprising a driveable shaft on the extender arranged to be connected to a drive shaft on the base vehicle to provide power to the extender for driving the extender axle.

10. The improvement of claim 9 further comprising a dolly and a tip stand connected to said vehicle extender for supporting the vehicle extender when it is not connected to the base vehicle.

11. The improvement of claim 9 further comprising a cargo bed on the extender which mates with the cargo bed of the base vehicle.

12. The improvement of claim 9 wherein one of the connection areas includes two alignment wedges at the front of the extender, one on each side of the extender, for mating with the notched blocks at the back of the chassis.

13. The combination of a base vehicle and a vehicle extender, comprising:
a base vehicle having a chassis, notched blocks at the back of the chassis, body including a cargo bed, engine, tires, an electrical system, an air system and a brake system;
a vehicle extender having two wheels on an axle and a frame;
inter-engageable air, electrical and brake connectors to provide electrical and brake systems to the vehicle extender from the base vehicle; and
a connection assembly for removably connecting the vehicle extender to the base vehicle.

14. The combination of claim 13 wherein said connection assembly provides three connection areas between the vehicle extender and the base vehicle.

15. The combination of claim 14 further comprising a driveable shaft on the extender arranged to be connected to a drive shaft on the base vehicle to provide power to the extender for driving the extender axle.

16. The combination of claim 14 further comprising a dolly and a tip stand connected to said vehicle extender for supporting the vehicle extender when it is not connected to the base vehicle.

17. The combination of claim 14, further comprising a cargo bed on the extender which mates with the cargo bed of the base vehicle.

18. The combination of claim 14, wherein one of the connection areas includes alignment wedges at the front of the extender for mating with the notched blocks at the back of the chassis.

19. The combination of claim 13 further comprising a driveable shaft on the extender arranged to be connected to a drive shaft on the base vehicle to provide power to the extender for driving the extender axle; a cargo bed on the extender which mates with the cargo bed of the base vehicle; and wherein there are three connection areas between the vehicle extender and the base vehicle, one of the connection areas including at least two alignment wedges at the front of the extender, one on each side of the extender, for mating with at least two of the notched blocks at the back of the chassis, one on each side of the chassis, the wedges being located on an inclined surface, the blocks being located on an inclined surface which mates with the inclined surfaces on which the wedges are located, there being at least two block on each inclined surface and there being at least two wedges on each inclined surface, another of the connection areas including a cross beam above the wedges and notched blocks secured to the rear of the vehicle, the third connection being located between the cross beam and the wedges and notched blocks and providing a clamping effect provided by a pin in the frame of the base vehicle having an opening, and a bolt extending through said opening and being secured to a box mounted to the frame of the extender.

20. The combination of claim 19 further comprising a dolly and a tip stand connected to said vehicle extender for supporting the vehicle extender when it is not connected to the base vehicle.
